(19) United States
(12) Patent Application Publication
(10) Pub. No.: US 2024/0328471 A1
(43) Pub. Date: Oct. 3, 2024

(54) BALL SCREW DRIVE, METHOD FOR PRODUCING A BALL SCREW DRIVE, AND VEHICLE BRAKE

(71) Applicant: ZF Active Safety GmbH, Koblenz (DE)

(72) Inventors: Volker Knop, Ulmen (DE); Michael Weins, Muenstermaifeld (DE)

(21) Appl. No.: 18/616,243

(22) Filed: Mar. 26, 2024

(30) Foreign Application Priority Data
Mar. 27, 2023 (DE) 102023107722.8

(51) Int. Cl. F16D 65/16; F16D 125/40; F16H 25/22; F16H 25/24

(52) U.S. Cl. CPC F16D 65/16; F16H 25/2204; F16H 25/24; F16D 2125/40; F16H 2025/2481; F16H 2025/249

(57) ABSTRACT

A ball screw drive for an actuator assembly of a vehicle brake is disclosed. The ball screw drive has a rotatably mounted recirculating ball screw spindle, on which a spindle nut open on one side is mounted. At least one thread groove is formed on the circumferential surface of the recirculating ball screw spindle, and a corresponding thread groove is formed on the inner surface of the spindle nut. A multiplicity of balls is guided in the thread grooves in such a way that rotation of the recirculating ball screw spindle brings about axial movement of the spindle nut along a rotational axis of the recirculating ball screw spindle. The spindle nut is hardened by ferritic nitrocarburizing. Moreover, a method for producing a ball screw drive and a vehicle brake are disclosed.

### CROSS-REFERENCE TO RELATED APPLICATION

This application claims priority to German Priority application Ser. No. 102023107722.8, filed Mar. 27, 2023, the disclosure of which is incorporated herein by reference in its entirety.

### TECHNICAL FIELD

The disclosure relates to a ball screw drive for an actuator assembly of a vehicle brake, to a method for producing a ball screw drive, and to a vehicle brake having an actuator assembly. The ball screw drive has a recirculating ball screw spindle, on which a spindle nut is mounted.

### BACKGROUND

In an actuator assembly for a vehicle brake, the spindle nut forms the brake piston. This means that the spindle nut projects partially into a gap of a brake caliper in order to apply a brake pad to a brake rotor.

When the vehicle brake is actuated, axial and radial forces cause surface pressures in the spindle nut, for example in the region of a thread groove and at an end which is remote from the gap and by which the spindle nut is supported axially against a bearing surface.

These surface pressures promote wear of the spindle nut.

Moreover, the spindle nut projects partially into a gap of a brake caliper in order to apply a brake pad to a brake rotor. As a result, the spindle nut is exposed to environmental effects e.g. moisture, for example, salty spray, whereby corrosion of the spindle nut is promoted.

Due to conventional coating methods for applying corrosion protection, the surface structure following a previous hardening process is modified, making the material at the surface softer or porous. As a result, spindle nuts which have corrosion protection are less resistant to surface pressure in the region of the thread groove. This has the effect that the spindle nut wears more quickly.

### SUMMARY

What is needed is to provide a ball screw drive for an actuator assembly of a vehicle brake which is optimized in respect of its corrosion resistance and its resistance to surface pressure.

According to the disclosure, a ball screw drive for an actuator assembly of a vehicle brake is provided, having a rotatably mounted recirculating ball screw spindle, on which a spindle nut open on one side is mounted. At least one thread groove is formed on a circumferential surface of a recirculating ball screw spindle, and a corresponding thread groove is formed on the inner surface of the spindle nut. A multiplicity of balls is guided in the thread grooves in such a way that rotation of the recirculating ball screw spindle brings about axial movement of the spindle nut along a rotational axis of the recirculating ball screw spindle. The spindle nut is hardened by ferritic nitrocarburizing.

According to the disclosure, a method for producing a ball screw drive is also provided. More specifically, a ball screw drive according to the disclosure is provided, for an actuator assembly of a vehicle brake. In one method step, a spindle nut, which is open axially on one side and on the inner surface of which a thread groove is formed, is provided. The spindle nut is then ferritically nitrocarburized.

A spindle nut hardened by ferritic nitrocarburizing meets the requirements in respect of surface hardness and corrosion resistance, and therefore the spindle nut is sufficiently well protected from wear and has a correspondingly long life.

For example, the spindle nut has high fatigue resistance in relation to rolling contact stress in a region of the thread groove.

One exemplary advantage is that the corrosion protection provided by nitrocarburizing has a high temperature stability, for example up to 500° C. Thus, the corrosion protection is reliably maintained even when the spindle nut heats up during operation.

Moreover, the surface has a low coefficient of friction after nitrocarburizing, and this is advantageous in a region of the thread groove and in a region of a running surface of the spindle nut.

For example, the spindle nut is produced from alloyed or unalloyed steel.

Ferritic nitrocarburizing is a thermochemical method for enriching the surface of components produced from alloyed and unalloyed steel with nitrogen and carbon atoms by diffusion from the environment of corresponding donors to form a compound layer.

Below the compound layer is the “diffusion layer”, which is enriched with nitrogen.

The compound layer predominantly contains iron nitrides and iron carbonitrides, nitrides of alloying elements and, in an outer boundary layer, a porous zone.

Owing to its composition, the compound layer has a non-metallic character with a high surface hardness (up to 1500 HV0.1). The actual surface hardness depends on the duration of treatment and the material selected. Its surface thickness can be up to 30 μm.

The compound layer has a high resistance to wear and pitting, high-temperature corrosion resistance and good running properties. Thus, the compound layer has ideal properties for making the spindle nut resistant to Hertzian surface pressures and corrosion.

The diffusion layer includes nitrides and nitrogen mixed crystals. The nitrogen atoms are embedded in interstitial locations in the ferrite lattice and thereby produce lattice distortion. They are also present in nitrides which are precipitated out of the ferrite matrix. This hinders the deformation process.

The thickness of the diffusion layer is several tenths of a millimetre.

The diffusion layer improves, for example, a rolling contact fatigue strength of the spindle nut.

In an outer boundary layer, the compound layer has a porous region, which is also referred to as a porous zone.

The porous zone has a layer thickness of up to 10 μm.

In one exemplary arrangement, the spindle nut is nitrocarburized at a temperature of up to 700° C., at a temperature of from 570° C. to 580° C. Given such a treatment temperature, there is no phase transition in the material structure during nitrocarburizing, that is to say that the structure does not temporarily transform into a face-centred cubic lattice structure typical of austenite, as with conventional case hardening. Consequently, ferritic nitrocarburizing produces only minimal distortion. Finishing work on the surface is therefore not required. A compound layer which forms during nitrocarburizing is therefore retained in full.

According to one exemplary arrangement, the spindle nut is pretreated by hardening and tempering and/or surface hardening before nitrocarburizing. This additionally increases the resistance of the spindle nut to surface pressures.

The spindle nut can be nitrocarburized on its entire surface or only in some region or regions. In the case of nitrocarburizing in some region or regions, production costs can be reduced.

For example, the spindle nut is cooled in an oxidizing salt bath or in an oxidation atmosphere after nitrocarburizing. During this process, the pores of the porous zone fill with magnetite (black iron oxide). This gives rise to a good anti-corrosion layer.

The oxide layer has a thickness of up to 5 μm, for example.

After nitrocarburizing, the spindle nut can be smoothed in the region of the thread groove, whereby good running properties are achieved in the region of the thread groove.

If an oxidation as described above takes place in a salt bath or an oxidation atmosphere, the spindle nut is smoothed only after the oxidation.

The spindle nut is smoothed by polishing, lapping, glass bead blasting, brushing or barrel finishing, for example.

As an option, the oxide layer thickness lost during the microfinishing of the surface is thickened by re-oxidation.

The spindle nut is nitrocarburized by gas nitrocarburizing, salt-bath nitrocarburizing, plasma nitrocarburizing, or powder nitrocarburizing, or is nitrocarburized in a fluidized bed, for example. The methods mentioned are suitable for producing the desired properties in respect of surface hardness and corrosion resistance of the spindle nut.

According to the disclosure, a vehicle brake having an actuator assembly is also disclosed, having a ball screw drive according to the disclosure, the spindle nut of which is produced by a method according to the disclosure.

The disclosure furthermore relates to a brake piston for a vehicle brake according to the disclosure having an actuator assembly, having a ball screw drive according to the disclosure, wherein the spindle nut of the ball screw drive forms the brake piston.

### BRIEF DESCRIPTION OF DRAWINGS

Further advantages and features of the disclosure will be found in the following description and in the appended drawings, to which reference is made. In the drawings:

FIG. 1 shows a sectional view of a vehicle brake according to the disclosure having an actuator assembly according to the disclosure,

FIG. 2 shows a sectional view of a spindle nut of the actuator assembly of FIG. 1,

FIG. 3 shows schematically various layers of a material hardened by ferritic nitrocarburizing, and

FIG. 4 shows a diagram illustrating a method according to the disclosure for producing a ball screw drive.

### DETAILED DESCRIPTION

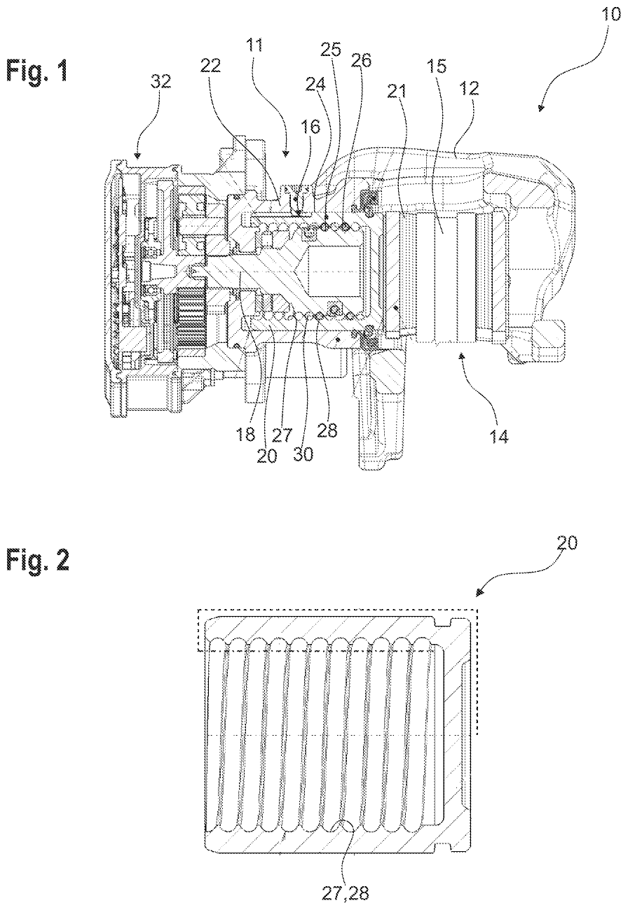

FIG. 1 shows a vehicle brake 10 having an actuator assembly 11.

The actuator assembly 11 comprises a brake caliper 12, in which a gap 14 for a brake rotor 15 is formed.

Moreover, the actuator assembly 11 comprises a ball screw drive 16, having a rotatably mounted recirculating ball screw spindle 18, on which a spindle nut 20 open on one side is mounted.

A sleeve-shaped section 22, on which a running surface 24 for the spindle nut 20 is formed, is formed in the brake caliper 12.

The spindle nut 20 forms a brake piston, which is used to apply a brake pad 21 to the brake rotor 15.

Axial movement of the spindle nut 20 is brought about by rotation of the recirculating ball screw spindle 18.

More specifically, at least one thread groove 26 is formed on the circumferential surface 25 of the recirculating ball screw spindle 18, and a corresponding thread groove 28 is formed on the inner surface 27 of the spindle nut 20, wherein a multiplicity of balls 30 is guided in the thread grooves 26, 28 in such a way that rotation of the recirculating ball screw spindle 18 brings about axial movement of the spindle nut 20 along a rotational axis of the recirculating ball screw spindle 18.

An electric motor (not visible in FIG. 1), which is coupled to the recirculating ball screw spindle 18 via a gear mechanism 32, is provided for driving the recirculating ball screw spindle 18.

As can be seen in FIG. 1, the spindle nut or brake piston 20 projects into the gap 14 and thus has an exposed outer surface in one section. The exposed outer surface is exposed to environmental effects such as moisture.

According to the disclosure, the spindle nut, the brake piston, 20, which is illustrated separately in FIG. 2, is hardened by ferritic nitrocarburizing.

In this way, the spindle nut or brake piston 20 meets the requirements in respect of surface durability and corrosion protection.

The spindle nut or brake piston 20 is nitrocarburized by gas nitrocarburizing, salt-bath nitrocarburizing, plasma nitrocarburizing, or powder nitrocarburizing, or is nitrocarburized in a fluidized bed.

The spindle nut or brake piston 20 can be nitrocarburized on its entire surface or only in some region or regions.

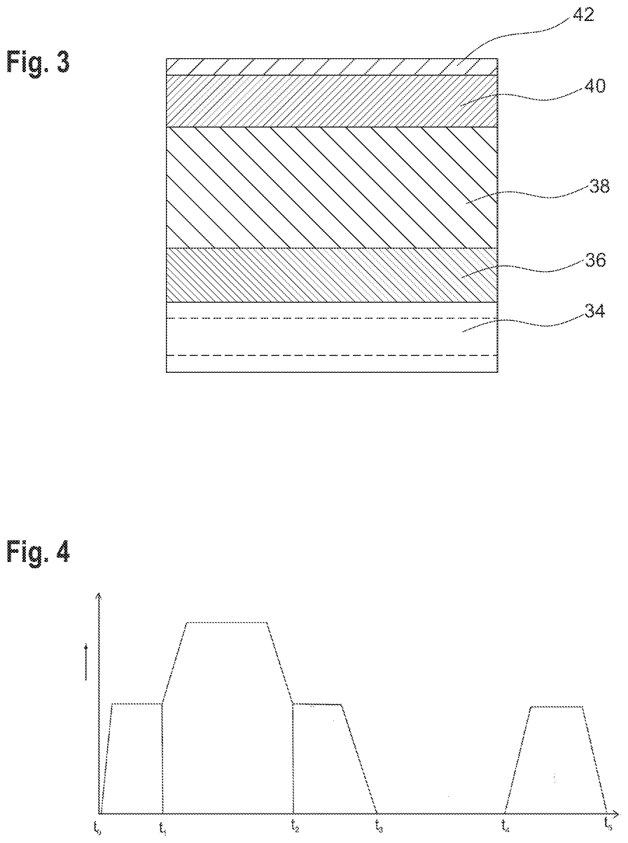

FIG. 3 illustrates the various layers, formed during hardening, of a component hardened by ferritic nitrocarburizing.

The innermost layer 34 forms the core material, which is alloyed or unalloyed steel, for example.

Adjoining the innermost layer 34 is a transitional layer 36, which forms a transition to a diffusion layer 38.

Adjoining the outward-facing side is a compound layer 40.

An oxide layer 42 is optionally provided on the outside.

A method for producing a ball screw drive 16 is explained below with reference to FIG. 4.

In FIG. 4, the processing temperature of the spindle nut or brake piston 20 is plotted against the processing time.

After the provision of a spindle nut open axially on one side at time to, the spindle nut 20 is optionally first of all pretreated by hardening and tempering and/or surface hardening.

Before ferritic nitrocarburizing, the spindle nut 20 is preheated.

After preheating, the spindle nut is heated from time t₁ to 700° C. In one exemplary arrangement, the spindle nut is heated from time t₁ to 580° C. During this process, the layers 34, 36, 38, 40 described in connection with FIG. 3 are formed, apart from oxide layer 42.

The oxide layer 42 is formed during a subsequent cooling process from time t₂. The cooling process takes place in an oxidizing salt bath or in an oxidation atmosphere.

After the temperature of the spindle nut 20 has fallen approximately to ambient temperature at time t₃, fine machining of the spindle nut 20 can take place.

During this process, the spindle nut 20 is smoothed in the region of the thread groove 28.

If necessary, re-oxidation can then take place from time t₅, during which the spindle nut 20 is heated up again.

The nitrocarburized spindle nut 20 can then be screwed onto a recirculating ball screw spindle 18, which is in turn inserted in an actuator assembly 11 of a vehicle brake 10.

1. A ball screw drive for an actuator assembly of a vehicle brake, comprising a rotatably mounted recirculating ball screw spindle, on which a spindle nut open on one side is mounted,
wherein at least one thread groove is formed on a circumferential surface of the recirculating ball screw spindle, and a corresponding thread groove is formed on an inner surface of the spindle nut, wherein a multiplicity of balls is guided in the thread grooves in such a way that rotation of the recirculating ball screw spindle brings about axial movement of the spindle nut along a rotational axis of the recirculating ball screw spindle, and
wherein the spindle nut is hardened by ferritic nitrocarburizing.

2. A method for producing a ball screw drive for an actuator assembly of a vehicle brake according to claim 1, comprising the following steps:
providing a spindle nut, which is open axially on one side and on the inner surface of which a thread groove is formed, and
ferritically nitrocarburizing the spindle nut.

3. The method according to claim 2, further comprising nitrocarburizing the spindle nut at a temperature of up to 700° C.

4. The Method according to claim 2, further comprising pretreating the spindle nut by hardening and tempering and/or surface hardening before nitrocarburizing.

5. The method according to claim 2, further comprising nitrocarburizing the spindle nut on its entire surface or only in some region or regions.

6. The method according to claim 2, further comprising cooling the spindle nut in an oxidizing salt bath or in an oxidation atmosphere after nitrocarburizing.

7. The method according to claim 2, further comprising smoothing the spindle nut in a region of the thread groove after nitrocarburizing.

8. The method according to claim 2, wherein the spindle nut is nitrocarburized by one of gas nitrocarburizing, salt-bath nitrocarburizing, plasma nitrocarburizing, or powder nitrocarburizing, or is nitrocarburized in a fluidized bed.

9. A vehicle brake having an actuator assembly, comprising a ball screw drive according to claim 1.

10. A brake piston for a vehicle brake according to claim 9, wherein the spindle nut of the ball screw drive forms the brake piston.

11. The method according to claim 2, further comprising nitrocarburizing the spindle nut at a temperature within the range of 570° C. to 580° C.

12. The method according to claim 3, further comprising pretreating the spindle nut by hardening and tempering and/or surface hardening before nitrocarburizing.

13. The method according to claim 4, further comprising nitrocarburizing the spindle nut on its entire surface or only in some region or regions.

14. The method according to claim 13 further comprising cooling the spindle nut in an oxidizing salt bath or in an oxidation atmosphere after nitrocarburizing.

15. The method according to claim 14, further comprising smoothing the spindle nut in a region of the thread groove after nitrocarburizing.

16. The method according to claim 15, wherein the spindle nut is nitrocarburized by one of gas nitrocarburizing, salt-bath nitrocarburizing, plasma nitrocarburizing, or powder nitrocarburizing, or is nitrocarburized in a fluidized bed.
